(19) United States
(12) Patent Application Publication
(10) Pub. No.: US 2025/0375870 A1
(43) Pub. Date: Dec. 11, 2025

(54) BICYCLE WORK STAND

(71) Applicant: Louis CHUANG, TAICHUNG (TW)

(72) Inventor: Louis CHUANG, TAICHUNG (TW)

(21) Appl. No.: 19/174,278

(22) Filed: Apr. 9, 2025

(30) Foreign Application Priority Data
Jun. 5, 2024 (TW) 113120909

(51) Int. Cl. B25H 1/00; B25H 1/06; B62H 3/02; F16M 11/24; F16M 11/28

(52) U.S. Cl. CPC B25H 1/0014; B25H 1/06; B62H 3/02; F16M 11/245; F16M 11/28

(57) ABSTRACT

A bicycle work stand includes a leg support and a clamping head. The leg support consists of an upright rod and a base. The clamping head includes a fixed clamp, an extension rod, a movable clamp, a screw rod, and a latching mechanism. The screw rod is pivotally connected to the fixed clamp at one end and to a rotating handle at the other. The movable clamp is sleeved on the screw rod. The latching mechanism includes a pressing button, a linkage rod, and a latching assembly with a threaded portion. The pressing button allows the threaded portion to engage or disengage the screw rod, controlling the movable clamp.

### BACKGROUND OF THE INVENTION

The present invention relates to a work stand and, more particularly, to a bicycle work stand.

Taiwan Patent No. TWM525826 discloses a bike-maintenance rack, which includes a lifting column, a joint, and a clamp. The clamp includes a fixed seat and a movable clip pivoted on the fixed seat. The fixed seat includes a cantilever at one end, and the cantilever includes a fixed block. The fixed seat includes a fixed clip at one end. The fixed clip is spaced apart from the movable clip, so that a clamping space is formed between the fixed clip and the movable clip. The clamp further includes a handle, a pull rod 76, and a spring. A convex portion is formed at one end of the handle, and one end of the pull rod is pivoted on the convex portion of the handle. A threaded portion is formed at one end of the pull rod, and the threaded portion of the pull rod passes through the movable clip and is screwed into the fixed seat. By rotating the handle, the convex portion can be used to press the movable clip, so that the movable clip is lowered and the distance between the movable clip and the fixed clip is shortened.

However, the clamp of the aforementioned bike-maintenance rack can only adjust the width of the clamping space by rotating the pull rod. The design of adjusting the width through the threaded structure of the pull rod fails to allow for a quick adjustment of the clamping space.

### SUMMARY OF THE INVENTION

The invention provides a bicycle work stand including a leg support and a clamping head. The leg support includes an upright rod and a base. The base is connected to a lower edge of the upright rod along a vertical direction. The clamping head includes a fixed clamp, an extension rod, a movable clamp, a screw rod, and a latching mechanism. The fixed clamp is connected to the upright rod adjacent to an upper edge of the upright rod along the vertical direction. One end of the extension rod is connected to the fixed clamp. The movable clamp is connected to another end of the extension rod opposite to the fixed clamp. One end of the screw rod is pivotally connected to the fixed clamp, and the other end of the screw rod is rotatably connected to a rotating handle to rotate synchronously. The movable clamp is sleeved on the screw rod such that the rotating handle is disposed on a side of the movable clamp opposite to the fixed clamp. The latching mechanism includes a pressing button, a linkage rod, and a latching assembly. The pressing button is connected to the movable clamp and movable between a released position and a pressed position. One end of the linkage rod is connected to the pressing button, and the movement of the pressing button allows the linkage rod to pivotally swing. The latching assembly is arranged inside the fixed clamp and connected to the linkage rod. The latching assembly has a threaded portion. When the pressing button is in the released position, the threaded portion engages the screw rod. When the pressing button is in the pressed position, the threaded portion disengages from the screw rod.

In an example, the latching assembly includes a sliding seat and a latching block. The sliding seat is slidably disposed within the fixed clamp. The latching block is movably connected to the sliding seat such that the latching block moves with the sliding seat. The threaded portion is disposed on the latching block. When the pressing button is in the released position, the sliding seat moves closer to the screw rod. When the pressing button is in the pressed position, the sliding seat moves away from the screw rod.

In an example, an accommodating groove is disposed inside the movable clamp. The linkage rod includes a pushing member, a swinging member, a rotating member, and a lever. The pushing member is connected to the pressing button and the swinging member. The swinging member is rotatably disposed within the accommodating groove about the rotating member as a center. One end of the rotating member is rotatably connected to the swinging member to rotate synchronously, and the other end of the rotating member is rotatably connected to the lever to rotate synchronously. One end of the lever opposite to the rotating member is disposed within the fixed clamp. A latching groove is arranged on a side of the sliding seat opposite to the screw rod. A radial outer edge of the lever is inserted into the latching groove such that the rotation of the lever drives the sliding seat to move closer to or away from the screw rod.

In an example, a sliding surface and an insertion hole are disposed on a side of the sliding seat adjacent to the screw rod. A distance from one end of the sliding surface adjacent to the rotating handle to the screw rod is smaller than a distance from an end of the sliding surface opposite to the rotating handle to the screw rod. The insertion hole is disposed on a side of the sliding surface opposite to the rotating handle. The latching assembly includes a stopper member and an elastic member. The stopper member is threadedly coupled to the insertion hole. One end of the elastic member is inserted into the insertion hole and abuts against the stopper member, and the other end of the elastic member abuts against the latching block. The elastic member is configured to push the latching block in a direction closer to the rotating handle.

In an example, the fixed clamp is provided with a sliding block movably disposed within the fixed clamp in a direction parallel to an axial direction of the screw rod. One end of the screw rod opposite to the rotating handle is pivotally connected to the sliding block. The sliding block is provided with a pivoting groove in the direction parallel to the axial direction of the screw rod. The pivoting groove includes two wide portions and a narrow portion. The two wide portions are fan-shaped. The narrow portion is disposed between the two wide portions. The lever is inserted into the pivoting groove.

In an example, the pressing button is connected to a recoil member disposed within the movable clamp. One end of the recoil member abuts against the movable clamp, and the other end of the recoil member abuts against the pressing button. The recoil member is configured to push the pressing button toward the released position.

In an example, the base includes a sliding foundation, a plurality of supporting legs, and a plurality of linking rods. The sliding foundation is slidably connected to the upright rod between a folded position and an unfolded position. One end of each of the plurality of supporting legs is pivotally connected to the sliding foundation. One end of each of the plurality of linking rods is pivotally connected to the upright rod, and the other end of each of the plurality of linking rods is pivotally connected to the plurality of supporting legs. When the sliding foundation is in the folded position, the plurality of supporting legs are moved closer to the upright rod. When the sliding foundation is in the unfolded position, the plurality of supporting legs are expanded away from the upright rod.

The present invention will become clearer in light of the following detailed description of illustrative embodiments of this invention described in connection with the drawings.

### BRIEF DESCRIPTION OF DRAWINGS

FIG. 1 is a perspective view of a bicycle work stand according to the present invention.

FIG. 2 is an exploded perspective view of a linkage rod of the bicycle work stand of FIG. 1.

FIG. 3 is an exploded perspective view of a latching assembly rod of the bicycle work stand of FIG. 1.

FIG. 4 is a cross-sectional view of a pressing button of the bicycle work stand when the pressing button is in a released position.

FIG. 5 is a cross-sectional view of a swinging member of the bicycle work stand when the pressing button is in a pressed position.

FIG. 6 is a cross-sectional view of a lever of the bicycle work stand when the pressing button is in the pressed position.

FIG. 7 is a cross-sectional view of the bicycle work stand of FIG. 1.

FIG. 8 is a cross-sectional view of the pressing button of the bicycle work stand when the pressing button is in the pressed position.

FIG. 9 is a cross-sectional view of the swinging member of the bicycle work stand when the pressing button is in the pressed position.

FIG. 10 is a cross-sectional view of the lever of the bicycle work stand when the pressing button is in the pressed position.

FIG. 11 is an operational diagram of a movable clamp moving away from a fixed clamp.

FIG. 12 is an operational diagram of the movable clamp moving closer to the fixed clamp.

FIG. 13 is an operational diagram of a latching block moving on a sliding surface.

### DETAILED DESCRIPTION OF THE INVENTION

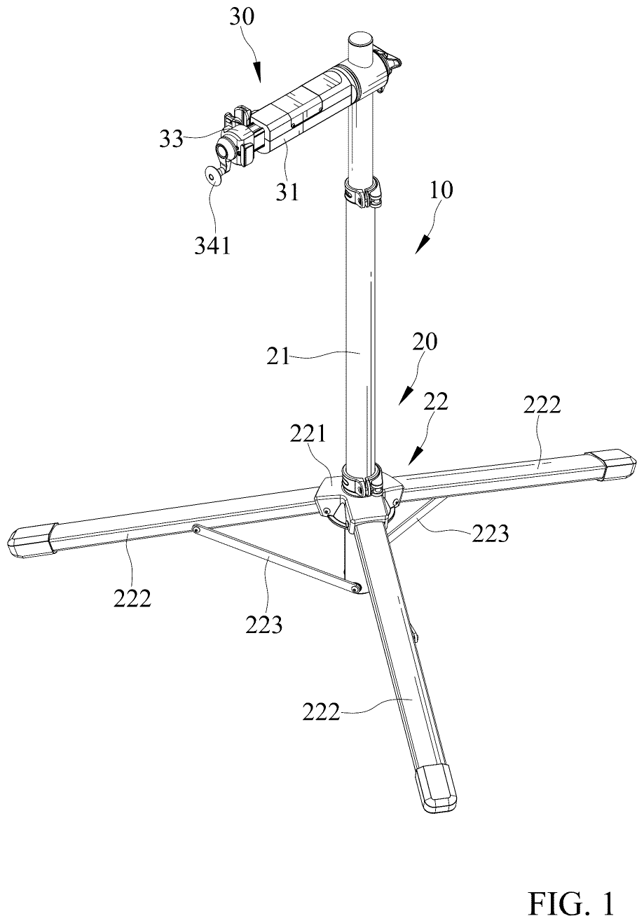

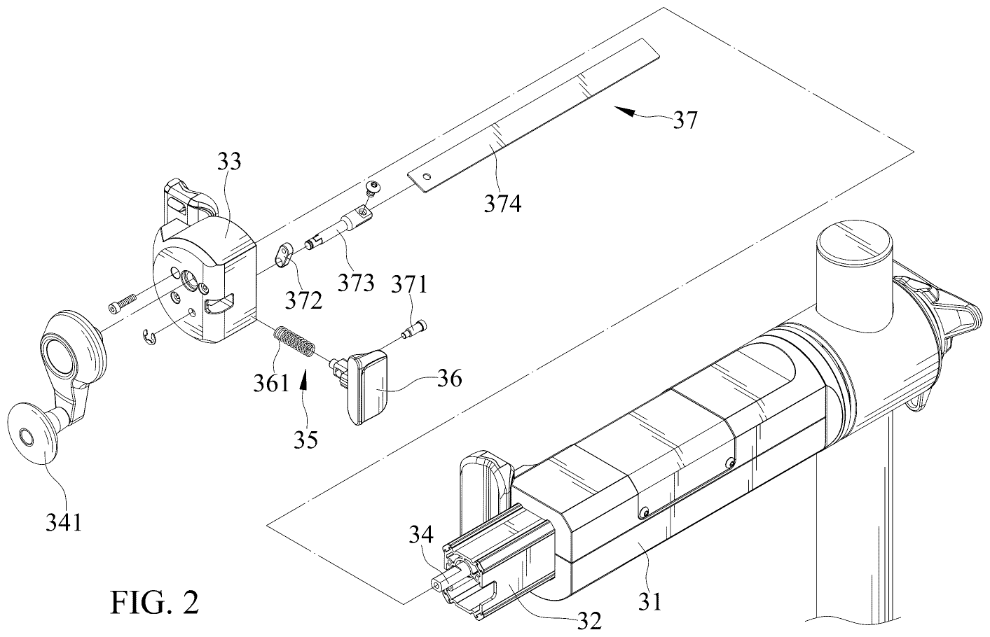

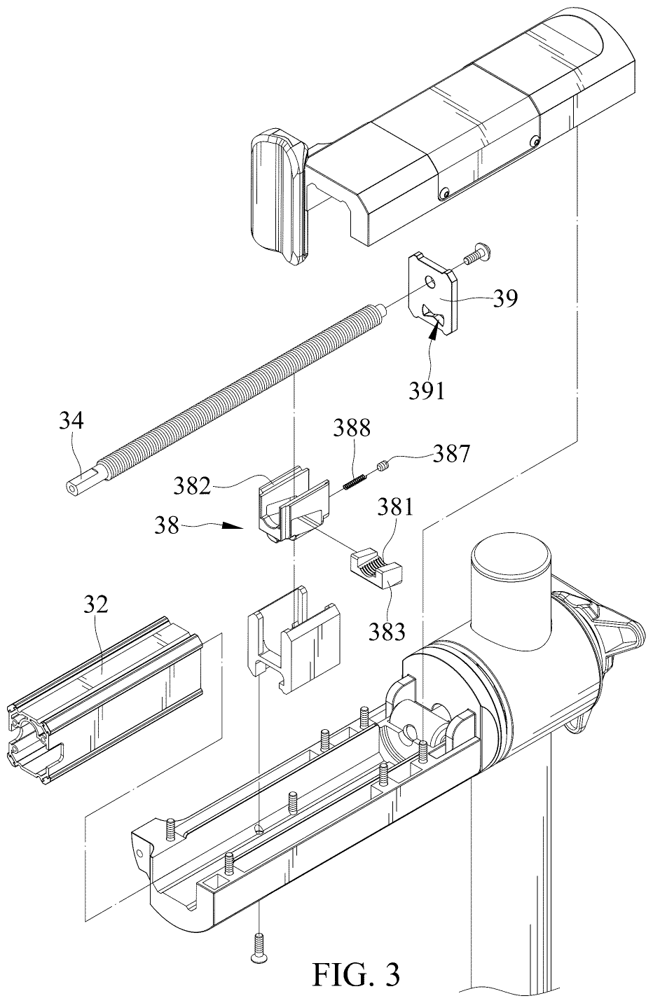

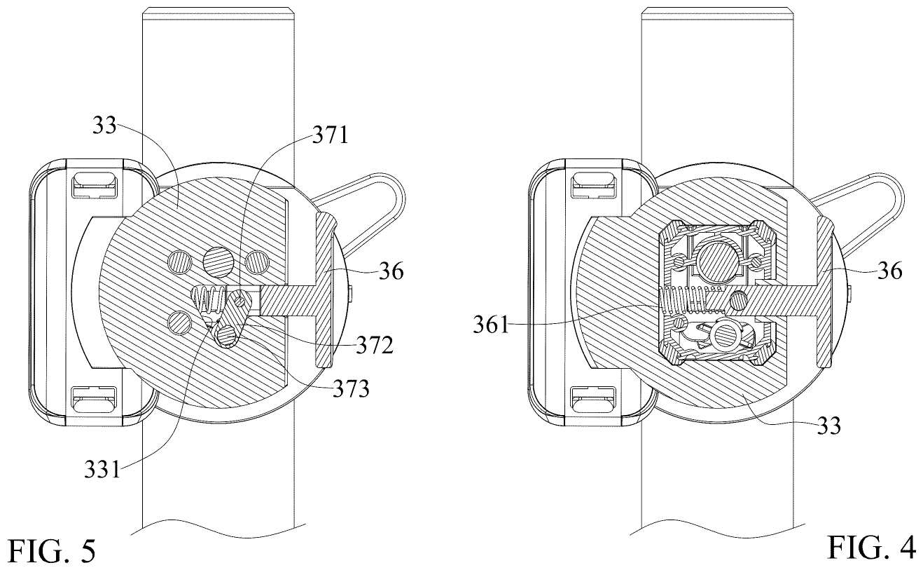

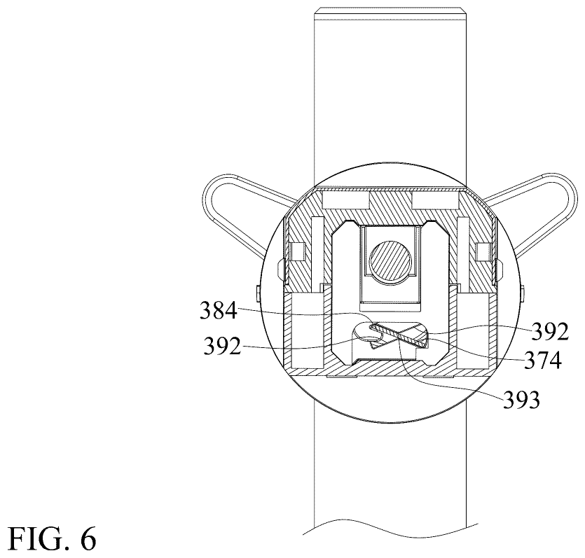

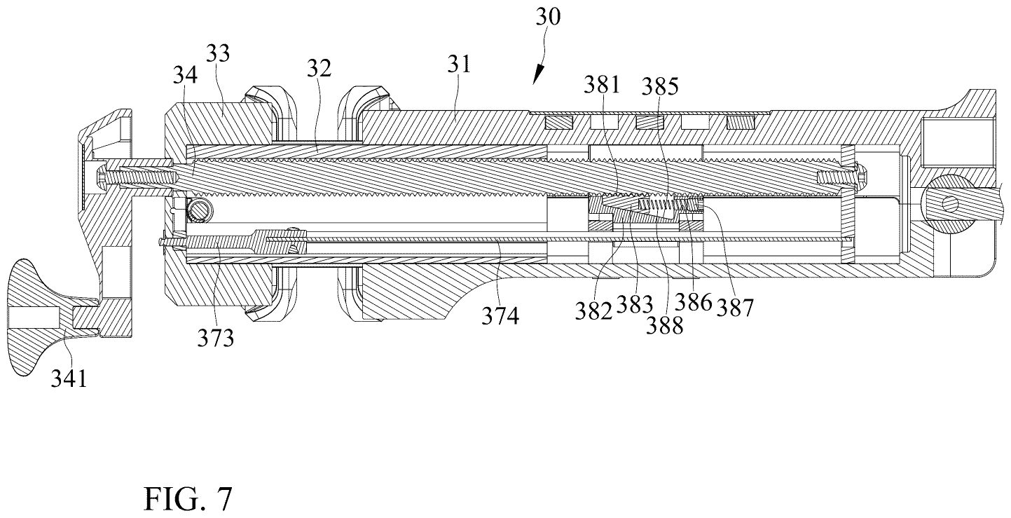

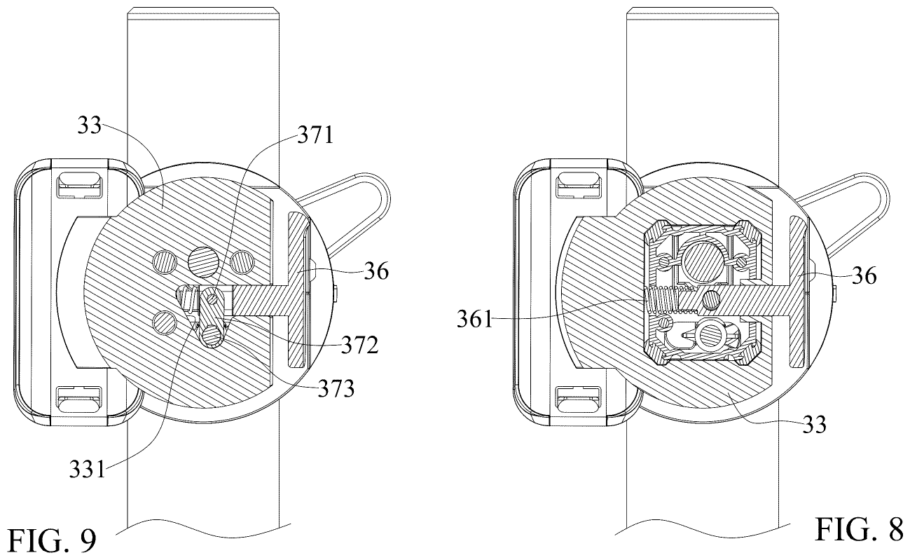

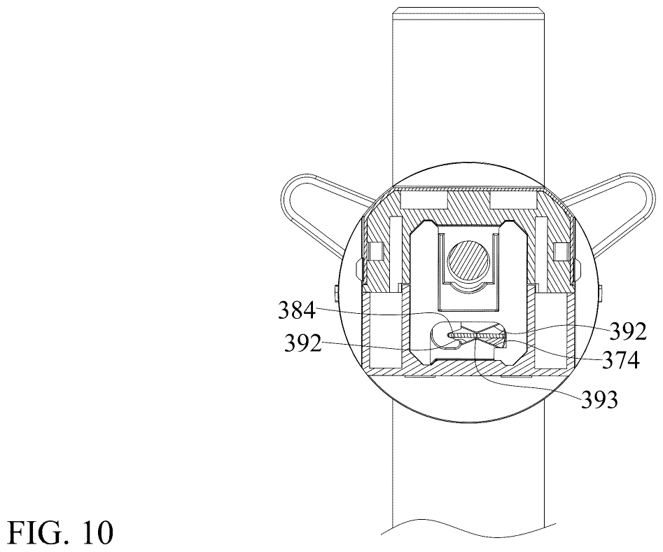

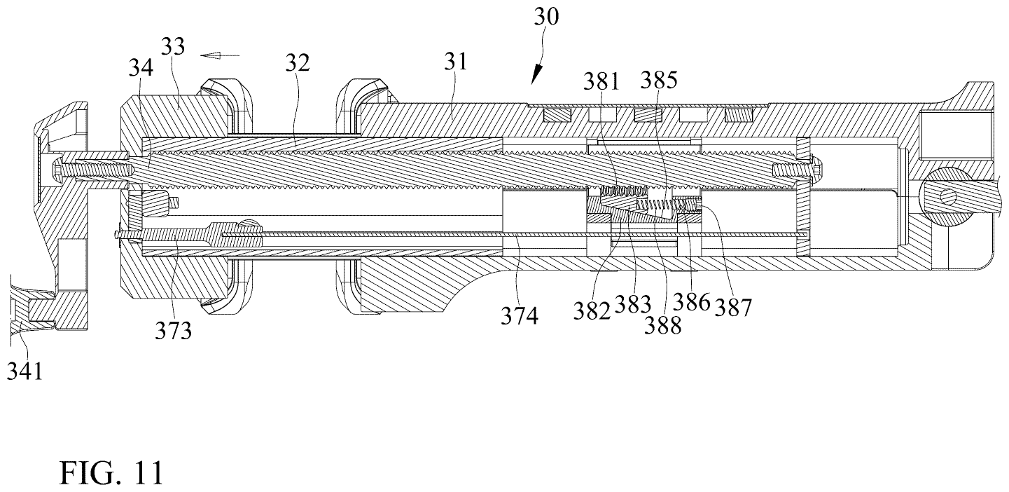

Referring to FIGS. 1 to 14, the present invention relates to a bicycle work stand 10, which includes a leg support 20 and a clamping head 30, wherein:

The leg support 20 includes an upright rod 21 and a base 22 connected to a lower edge of the upright rod 21 along a vertical direction.

The clamping head 30 includes a fixed clamp 31, an extension rod 32, a movable clamp 33, a screw rod 34, and a latching mechanism 35. The fixed clamp 31 is connected to the upright rod 21 adjacent to an upper edge of the upright rod 21 along the vertical direction. One end of the extension rod 32 is connected to the fixed clamp 31, and the movable clamp 33 is connected to the other end of the extension rod 32 opposite to the fixed clamp 31. One end of the screw rod 34 is pivotally connected to the fixed clamp 31, and the other end is rotatably connected to a rotating handle 341 to rotate synchronously. The movable clamp 33 is sleeved on the screw rod 34, such that the rotating handle 341 is disposed on a side of the movable clamp 33 opposite to the fixed clamp 31. The latching mechanism 35 includes a pressing button 36, a linkage rod 37, and a latching assembly 38. The pressing button 36 is movably connected to the movable clamp 33 and is movable between a released position and a pressed position. One end of the linkage rod 37 is connected to the pressing button 36, and the movement of the pressing button 36 causes the linkage rod 37 to pivotally swing. The latching assembly 38 is arranged inside the fixed clamp 31 and connected to the linkage rod 37. The latching assembly 38 has a threaded portion 381. When the pressing button 36 is in the released position, the threaded portion 381 engages the screw rod 34, and when the pressing button 36 is in the pressed position, the threaded portion 381 disengages from the screw rod 34.

The latching assembly 38 includes a sliding seat 382 and a latching block 383. The sliding seat 382 is slidably disposed within the fixed clamp 31, and the latching block 383 is movably connected to the sliding seat 382, allowing the latching block 383 to move with the sliding seat 382. The threaded portion 381 is disposed on the latching block 383. When the pressing button 36 is in the released position, the sliding seat 382 moves closer to the screw rod 34, and when the pressing button 36 is in the pressed position, the sliding seat 382 moves away from the screw rod 34.

An accommodating groove 331 is disposed inside the movable clamp 33. The linkage rod 37 includes a pushing member 371, a swinging member 372, a rotating member 373, and a lever 374. The pushing member 371 is connected to the pressing button 36 and the swinging member 372. The swinging member 372 is rotatably disposed within the accommodating groove 331 about the rotating member 373 as a center. One end of the rotating member 373 is rotatably connected to the swinging member 372 to rotate synchronously, and the other end of the rotating member 373 is rotatably connected to the lever 374 to rotate synchronously. One end of the lever 374 opposite to the rotating member 373 is disposed within the fixed clamp 31. A latching groove 384 is arranged on a side of the sliding seat 382 opposite to the screw rod 34. A radial outer edge of the lever 374 is inserted into the latching groove 384, such that the rotation of the lever 374 drives the sliding seat 382 to move closer to or away from the screw rod 34.

The sliding seat 382 has a sliding surface 385 and an insertion hole 386 disposed on a side adjacent to the screw rod 34. A distance from one end of the sliding surface 385 adjacent to the rotating handle 341 to the screw rod 34 is smaller than the distance from the opposite end of the sliding surface 385 to the screw rod 34. The insertion hole 386 is disposed on a side of the sliding surface 385 opposite to the rotating handle 341. The latching assembly 38 includes a stopper member 387 and an elastic member 388. The stopper 387 is threadedly coupled to the insertion hole 386. One end of the elastic member 388 is inserted into the insertion hole 386 and abuts against the stopper member 387, and the other end abuts against the latching block 383. The elastic member 388 is configured to push the latching block 383 in a direction closer to the rotating handle 341.

The fixed clamp 31 is provided with a sliding block 39 movably disposed within the fixed clamp 31 in a direction parallel to the axial direction of the screw rod 34. One end of the screw rod 34, opposite to the rotating handle 341, is pivotally connected to the sliding block 39. The sliding block 39 includes a pivoting groove 391, which is parallel to the axial direction of the screw rod 34. The pivoting groove 391 consists of two wide portions 392 and a narrow portion 393. The two wide portions 392 are fan-shaped, and the narrow portion 393 is disposed between the two wide portions 392. The lever 374 is inserted into the pivoting groove 391.

The pressing button 36 is connected to a recoil member 361 disposed inside the movable clamp 33. One end of the recoil member 361 abuts against the movable clamp 33, and the other end abuts against the pressing button 36. The recoil member 361 is configured to push the pressing button 36 toward the released position.

The base 22 includes a sliding foundation 221, a plurality of supporting legs 222, and a plurality of linking rods 223. The sliding foundation 221 is slidably connected to the upright rod 21 between a folded position and an unfolded position. One end of each of the plurality of supporting legs 222 is pivotally connected to the sliding foundation 221. One end of each of the plurality of linking rods 223 is pivotally connected to the upright rod 21, and the other end of each of the plurality of linking rods 223 is pivotally connected to the supporting legs 222. When the sliding foundation 221 is in the folded position, the supporting legs 222 move closer to the upright rod 21. When the sliding foundation 221 is in the unfolded position, the supporting legs 222 expand away from the upright rod 21.

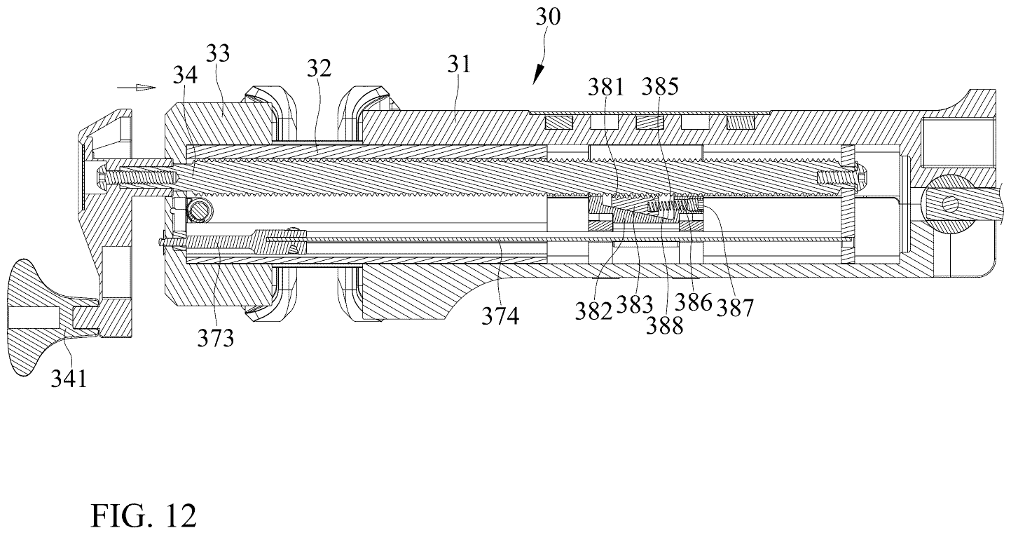

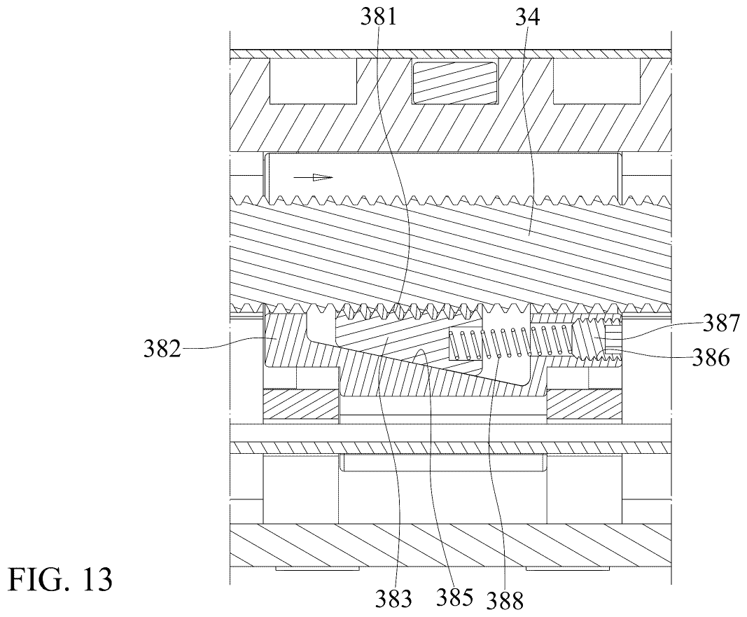

The bicycle work stand 10, through the aforementioned structure, allows for quick opening and closing of the clamping head 30. When the pressing button 36 is in the released position, a user can rotate the rotating handle 341, utilizing the engagement between the threaded portion 381 and the screw rod 34 to move the movable clamp 33 closer to or away from the fixed clamp 31 along the thread structure of the screw rod 34. Additionally, the user can press the pressing button 36 to switch it to the pressed position. After the latching block 383 disengages from the screw rod 34, the user can directly pull the movable clamp 33 for linear movement, enabling the movable clamp 33 to quickly move closer to or away from the fixed clamp 31. Alternatively, when the pressing button 36 is in the released position, the user can also directly push the movable clamp 33 in the direction closer to the fixed clamp 31, as shown in FIG. 12. Even if the latching block 383 engages the screw rod 34, the user can still apply pushing force to make the latching block 383 move along the sliding surface 385, as shown in FIG. 13. This movement causes the threaded portion 381 to disengage from the screw rod 34, thereby allowing the movable clamp 33 to quickly clamp objects.

Although specific embodiments have been illustrated and described, numerous modifications and variations are still possible without departing from the scope of the invention. The scope of the invention is limited by the accompanying claims.

1. A bicycle work stand, comprising:
a leg support including an upright rod and a base, wherein the base is connected to a lower edge of the upright rod along a vertical direction; and a clamping head including a fixed clamp, an extension rod, a movable clamp, a screw rod, and a latching mechanism, wherein the fixed clamp is connected to the upright rod adjacent to an upper edge of the upright rod along the vertical direction, wherein one end of the extension rod is connected to the fixed clamp, wherein the movable clamp is connected to another end of the extension rod opposite to the fixed clamp, wherein one end of the screw rod is pivotally connected to the fixed clamp, and the other end of the screw rod is rotatably connected to a rotating handle to rotate synchronously, wherein the movable clamp is sleeved on the screw rod such that the rotating handle is disposed on a side of the movable clamp opposite to the fixed clamp, wherein the latching mechanism includes a pressing button, a linkage rod, and a latching assembly, wherein the pressing button is connected to the movable clamp and movable between a released position and a pressed position, wherein one end of the linkage rod is connected to the pressing button, and the movement of the pressing button allows the linkage rod to pivotally swing, wherein the latching assembly is arranged inside the fixed clamp and connected to the linkage rod, wherein the latching assembly has a threaded portion, wherein when the pressing button is in the released position, the threaded portion engages the screw rod, and wherein when the pressing button is in the pressed position, the threaded portion disengages from the screw rod.

2. The bicycle work stand of claim 1, wherein the latching assembly includes a sliding seat and a latching block, wherein the sliding seat is slidably disposed within the fixed clamp, wherein the latching block is movably connected to the sliding seat such that the latching block moves with the sliding seat, wherein the threaded portion is disposed on the latching block, wherein when the pressing button is in the released position, the sliding seat moves closer to the screw rod, and wherein when the pressing button is in the pressed position, the sliding seat moves away from the screw rod.

3. The bicycle work stand as claimed in claim 2, wherein an accommodating groove is disposed inside the movable clamp, wherein the linkage rod includes a pushing member, a swinging member, a rotating member, and a lever, wherein the pushing member is connected to the pressing button and the swinging member, wherein the swinging member is rotatably disposed within the accommodating groove about the rotating member as a center, wherein one end of the rotating member is rotatably connected to the swinging member to rotate synchronously, and the other end of the rotating member is rotatably connected to the lever to rotate synchronously, wherein one end of the lever opposite to the rotating member is disposed within the fixed clamp, wherein a latching groove is arranged on a side of the sliding seat opposite to the screw rod, and wherein a radial outer edge of the lever is inserted into the latching groove such that the rotation of the lever drives the sliding seat to move closer to or away from the screw rod.

4. The bicycle work stand as claimed in claim 2, wherein a sliding surface and an insertion hole are disposed on a side of the sliding seat adjacent to the screw rod, wherein a distance from one end of the sliding surface adjacent to the rotating handle to the screw rod is smaller than a distance from an end of the sliding surface opposite to the rotating handle to the screw rod, wherein the insertion hole is disposed on a side of the sliding surface opposite to the rotating handle, wherein the latching assembly includes a stopper member and an elastic member, wherein the stopper member is threadedly coupled to the insertion hole, wherein one end of the elastic member is inserted into the insertion hole and abuts against the stopper member, and the other end of the elastic member abuts against the latching block, and wherein the elastic member is configured to push the latching block in a direction closer to the rotating handle.

5. The bicycle work stand of claim 3, wherein the fixed clamp is provided with a sliding block movably disposed within the fixed clamp in a direction parallel to an axial direction of the screw rod, wherein one end of the screw rod opposite to the rotating handle is pivotally connected to the sliding block, wherein the sliding block is provided with a pivoting groove in the direction parallel to the axial direction of the screw rod, wherein the pivoting groove includes two wide portions and a narrow portion, wherein the two wide portions are fan-shaped, wherein the narrow portion is disposed between the two wide portions, and wherein the lever is inserted into the pivoting groove.

6. The bicycle work stand of claim 1, wherein the pressing button is connected to a recoil member disposed within the movable clamp, wherein one end of the recoil member abuts against the movable clamp, and the other end of the recoil member abuts against the pressing button, and wherein the recoil member is configured to push the pressing button toward the released position.

7. The bicycle work stand of claim 1, wherein the base includes a sliding foundation, a plurality of supporting legs, and a plurality of linking rods, wherein the sliding foundation is slidably connected to the upright rod between a folded position and an unfolded position, wherein one end of each of the plurality of supporting legs is pivotally connected to the sliding foundation, wherein one end of each of the plurality of linking rods is pivotally connected to the upright rod, and the other end of each of the plurality of linking rods is pivotally connected to the plurality of supporting legs, wherein when the sliding foundation is in the folded position, the plurality of supporting legs are moved closer to the upright rod, and wherein when the sliding foundation is in the unfolded position, the plurality of supporting legs are expanded away from the upright rod.
